(19) United States
(12) Patent Application Publication
(10) Pub. No.: US 2006/0118552 A1
(43) Pub. Date: Jun. 8, 2006

(54) Use of shielding to optimize heating of microwaveable food products

(75) Inventor: Jason Tiefenback, Philadelphia, PA (US)

Correspondence Address: GOODWIN PROCTER LLP, 599 LEXINGTON AVENUE, NEW YORK, NY, 10022, US

(73) Assignee: Campbell Soup Company

(21) Appl. No.: 11/287,667

(22) Filed: Nov. 28, 2005

Related U.S. Application Data
(60) Provisional application No. 60/632,464, filed on Dec. 2, 2004.

(51) Int. Cl. H05B 6/80

(52) U.S. Cl. 219/729

(57) ABSTRACT

A method to control microwave heating of containers of foodstuff products to optimize heating of the foodstuff product, and reduce microwave activity is provided. Heating is optimized by selectively placing microwave shielding material around portions of side walls of the product container.

### CROSS REFERENCE TO RELATED APPLICATIONS

This application claims the benefit of priority of U.S. provisional application 60/632,464 filed on Dec. 2, 2004 which is incorporated by reference herein.

### FIELD OF THE INVENTION

This invention relates to a method for optimizing microwave heating of containers of foodstuff products, to prevent superheating of certain particles of foodstuff, and for minimizing the inherent microwave activity associated with heating foodstuffs. Optimization of heating and reduction of microwave activity is achieved by selectively placing microwave shielding material around or in portions of side walls of the product container.

### BACKGROUND OF THE INVENTION

Microwaveable packaging technology enables development of new and unique food products to suit various consumer needs. While convenience and time efficiency are obvious advantages of many of today's microwaveable food products, certain quality issues exist relating to minimizing superheating using presently available technology. It is commonly known that microwaving foods, whether in a retail package or in special cookware, often results in a final product that has portions which are superheated, and/or which exhibits microwave activity during heating. The phrase “microwave activity” refers to movement of the container, the generation of audible noises, and occasional splatter during heating, activity that inherently occurs during the microwave heating of foodstuffs. “Superheating” refers to overheating at least a portion of foodstuffs. Superheating and microwave activity detract from the eating experience and enjoyment of microwaved foods and may lead to consumers avoiding consumption of microwaveable products. Furthermore, while a user can always remove a container of food from the microwave, stir it, and replace it for additional heating, such extra steps result in delay and inconvenience to the consumer and reduce user satisfaction with available products. Additionally, stirring and replacing the container of food for further heating will not prevent microwave activity or superheating from occurring.

### SUMMARY OF INVENTION

Accordingly, it is an object of this invention to provide a package for microwaveable foodstuffs which optimizes heating of the foodstuff and reduces microwave activity during heating.

It is another object of this invention to provide a package for a microwaveable foodstuff such that the foodstuff is conveniently consumable right out of the package.

It is another object of this invention to provide labeling for foodstuff containers which selectively shield microwaves.

These and other objects of the invention are achieved by providing a container for microwaving foodstuffs comprising microwave shielding material, the container having a bottom and side walls and including a foodstuff, said shielding material arranged together with a portion of the side walls, whereby heating of said foodstuff is optimized. The invention also provides for a method for reducing microwave activity associated with subjecting a foodstuff in a container to microwaves, the container having a bottom and side walls, said method comprising affixing shielding material together with a portion of the side walls of said container.

### BRIEF DESCRIPTION OF THE DRAWINGS

FIG. 1 is a schematic illustration of a side view of container without any microwave shielding material;

FIG. 2 is a schematic illustration of a side view of a container having two shielding bands, one located near the top portion of the container and another located near the bottom portion of the container in accordance with the invention;

FIG. 3 is a schematic illustration of a bottom side view of a rounded bottomed container having two shielding bands, one located near the top portion of the container and another located near the bottom portion of the container in accordance with the invention;

FIG. 4 is a schematic illustration of a bottom side view of a container having a sharp corner between the side walls and bottom, and two shielding bands, one located near the top portion of the container and another located near the bottom portion of the container in accordance with the invention;

FIG. 5 is a schematic illustration of a bottom side view of container having a single shielding band located only near the top portion of the container in accordance with the invention;

FIG. 6 is a schematic illustration of a top view (FIG. 6a), and side top view (FIG. 6b), respectively, of an overcap having vent holes located in the center region of the top of the overcap in accordance with the invention;

FIG. 7 is a schematic illustration of a top view of overcap having vent holes located near the perimeter and in the center of the top of the overcap in accordance with the invention;

FIG. 8 is a schematic illustration of a top view of overcap having vent holes located near the perimeter of the overcap, and a shield covering a portion of the overcap in accordance with the invention; and

FIG. 9 is a schematic illustration of a top view of overcap having vent holes located near the perimeter and in the center of the top of the overcap, and a shield covering a portion of the overcap in accordance with the invention.

### DETAILED DESCRIPTION OF THE INVENTION

The invention relates to a microwaveable container for foodstuffs in general, and convenience food products in particular, which optimizes the heating of microwaveable products and reduces microwave activity during heating. The term “convenience food products” as used herein means foodstuffs which are directly consumed out of the microwaveable container. Microwave activity is reduced, in part, when superheating of foodstuff contents is reduced (i.e., when heating is optimized).

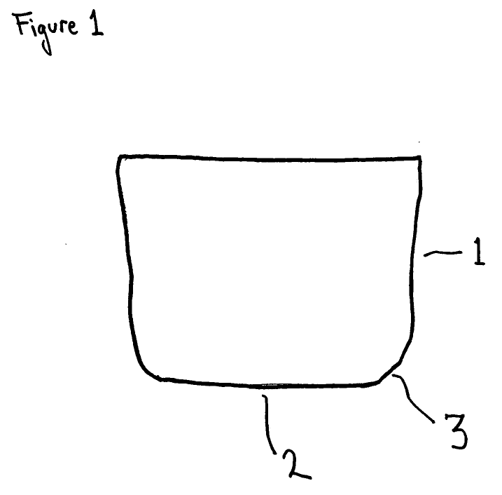

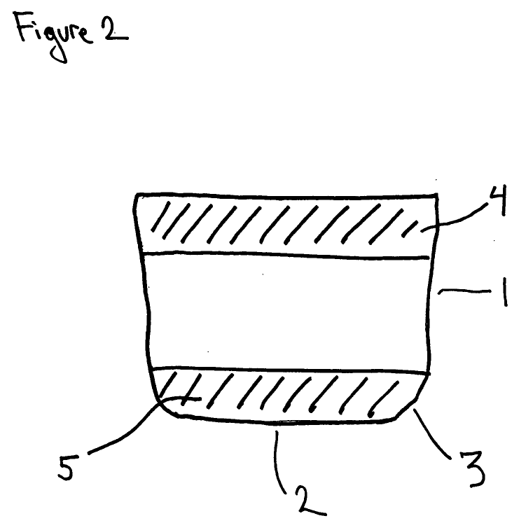

FIG. 1 is a schematic illustration of a typical container without any shielding. The container has a side wall (1) and bottom (2), a rounded bottom corner (3), and can be filled with a foodstuff. FIG. 2 illustrates the microwaveable container modified in accordance with invention. The container has both a top shielding band (“top band”) (4) and bottom shielding band (“bottom band”) (5) affixed to the outer surface of the side wall. The container or package can be made from any suitable material usable with foodstuffs and suitable for microwave uses. Such materials are readily ascertainable by those skilled in the art. Commonly used materials include, but are not limited to polypropylene, high density polyethylene, polystyrene, and low density polyethylene. Preferably, the container can be conveniently held by a consumer for direct consumption, however, the invention includes containers of any size. The container used for the examples described below had a side wall height of about 3 inches, an overcap cross-sectional diameter of about 4 inches, a bottom cross-sectional diameter of about 3½ inches.

The band comprises material that blocks microwaves (i.e., reflects, deflects, or absorbs microwaves). By including such material, the package controls the microwave energy that reaches the foodstuff within the container. By selectively placing the bands together with the container (e.g., either affixed to an external surface or integrally incorporated with the side wall) the heating of the foodstuff is controlled, or moderated, so that the product within the container is heated more uniformly. Additionally, it has been found that the microwave activity which inherently occurs during cooking is also reduced. Suitable materials for use in the invention that block microwave energy include but are not limited to metals. A preferable metal is aluminum. The selection of shielding materials, whether for use without any other materials or layers, or for use together with other materials or layers, is readily within the knowledge of those skilled in the art. The metal used can be in the form of a foil, film, tape, or other form. The material can be made by any suitable process, including but not limited to pressing or chemical deposition of the metal onto another material. The layer thickness can be any thickness usable for shielding purposes. The thickness and microwave opacity of any other material should be chosen to be suitable for microwave uses, and will be readily determinable by those skilled in the art. Microwave opacity is a commonly used measure of a material's blocking ability known to those skilled in the art. Typically microwave ovens generate microwaves having a frequency of 2.45 GHz. Microwave opacity corresponds to the degree to which microwaves transmit through a material. A suitable microwave opacity is 50% or more, preferably 90% or more. The aluminum used in the examples hereinbelow was in the form of foil or tape, with a thickness of about 5 mil., and had a microwave opacity of about 90-100%.

A band may include materials other than the microwave shielding material. For example, the band can include a layer or laminate of plastic material. The plastic material can be any type of plastic suitable for the purpose. In embodiments where the plastic will not come into contact with the foodstuff, issues of interaction between the plastic and foodstuff are not a concern. The plastic, or other material, can also serve as labeling for the packaged product. For example, a Plastishield label can be used. Plastishield is a coextruded polystyrene product made by American Fuji Seal. However, any suitable additional material can be used together with the material which shields microwaves.

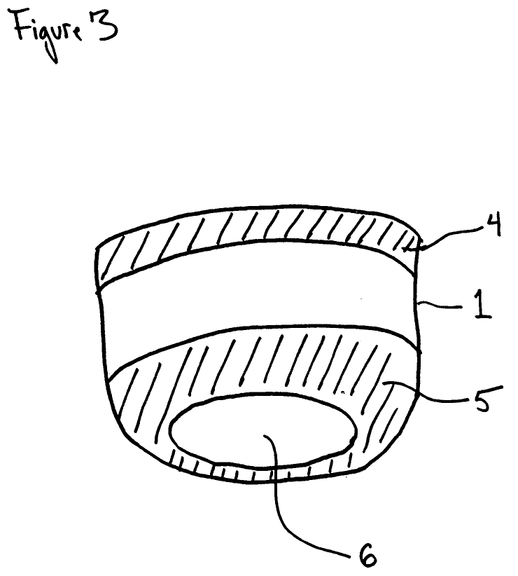

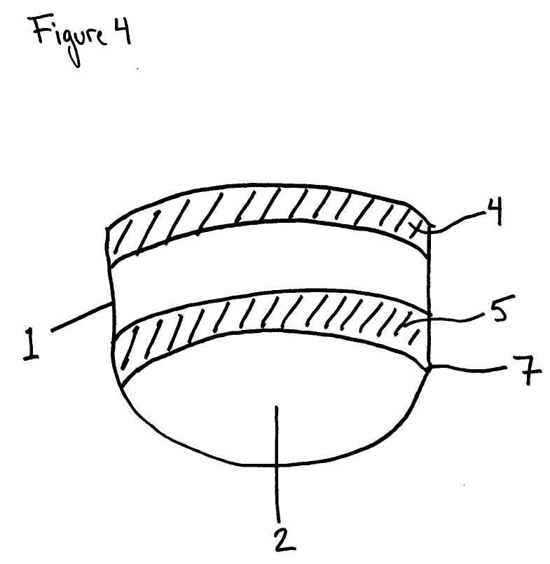

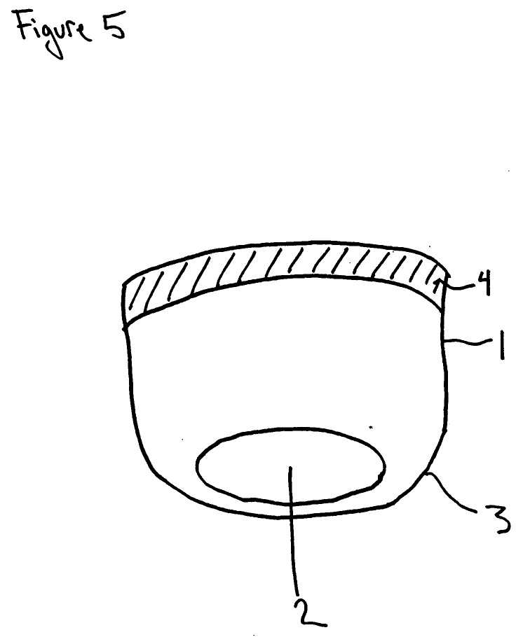

FIG. 3 is a schematic illustration of a bottom side view of a container in accordance with the invention having both a top band (4) and bottom band (5), wherein the container has rounded corners (3) and the bottom band extends around the rounded corner toward the bottom of the container. A central portion of the bottom of the container (6) is left uncovered. FIG. 4 is a schematic illustration of a bottom side view of a container having a sharp corner (7) between the side wall (1) and bottom (2). The container in FIG. 4 has both a top band (4) and a bottom band (5). The bottom band (5), in FIG. 4 does not extend around the corner to the bottom. In an alternate embodiment the bottom band (5) may extend around a portion of the bottom (2) in a manner similar to the container of FIG. 3. FIG. 5 is a schematic illustration of a container in accordance with the invention with a rounded bottom corner (3) between the side walls (1) and bottom (2), having only a top band (4).

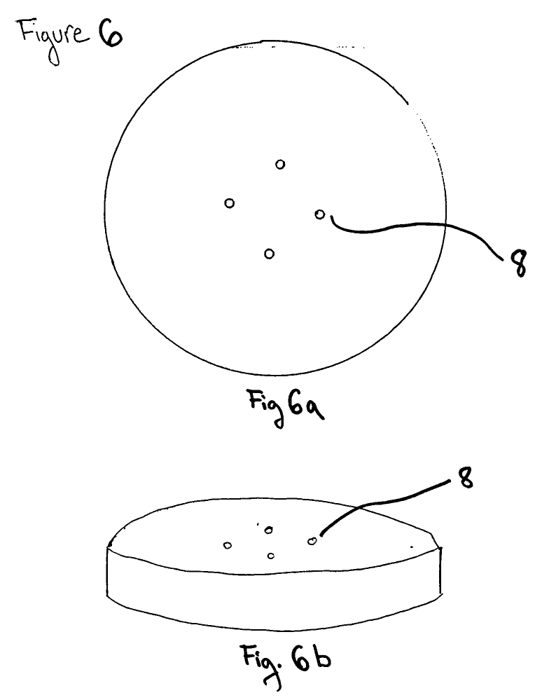

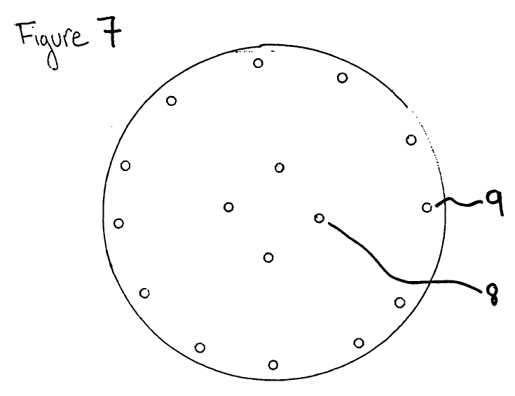

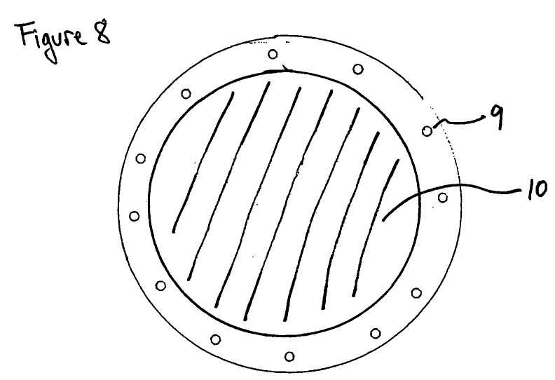

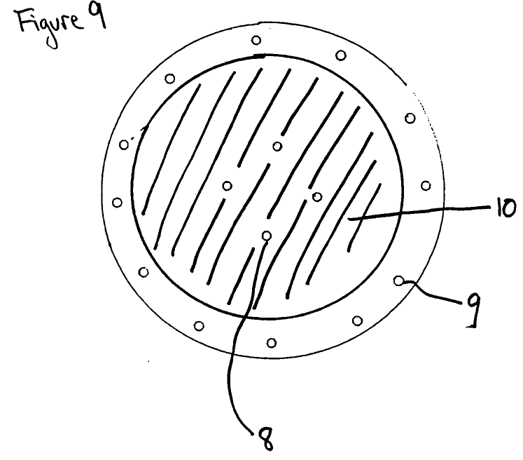

FIGS. 6(a) and 6(b) is a schematic illustration of a top and side view, respectively, of a typical overcap for a microwaveable container with 4 central vent holes (8). FIG. 7 is a schematic illustration of a top view of an overcap with 4 central vent holes (8) and 12 perimeter vent holes (9). FIG. 8 is a schematic illustration of an overcap with 12 perimeter vent holes (9) and an overcap shield (10). FIG. 9 is a schematic illustration of a top view of an overcap with central vent holes (8), perimeter vent holes (9), and an overcap shield (10).

The exact location of the shielding band may vary. Optimization of heating can be achieved by having a shielding band around the top portion of the side wall of the container (i.e. top band (4)), around the bottom portion of the side wall of the container (i.e. bottom band (5)), or around both the top and bottom portion of the side wall of the container (i.e. top band (4) and bottom band (5)).

The bands can be regular in shape, such as the continuous ribbon-like shape shown in the FIG. 2-4. However, the bands can have any shape, including irregular shapes with nonlinear edges. As shown in FIG. 2-4, a regularly shaped ribbon-like band covers a complete circumference around a top portion of the container. Although the top bands (4) illustrated in FIGS. 2-4 are flush to the top edge of the side wall, the top band need not be flush with the top edge of the side wall. Likewise, a bottom band (5) does not need to be flush with the corner, square or rounded, separating the side wall and the bottom. Furthermore, a bottom band (5) may, but need not extend around the corner and cover a portion of the bottom of the container.

Preferably, the band is incorporated onto the exterior of the container and does not directly contact the foodstuff. The attachment can be accomplished by any means commonly known by those skilled in the packaging arts. Methods can include gluing or integral incorporation during fabrication of the container. Shrink wrap techniques may be used to affix the shielding band to the container. Alternatively, a shielding band can be incorporated more intimately with the container during container manufacture. Intimate incorporation of a shielding band(s) can be achieved with an “insert molding” process.

Insert molding is a molding process whereby resin or plastic is injected or formed into a cavity around an insert piece, such as a piece of microwave shielding material, which is placed into the same cavity prior to molding. The result is a single piece with the insert adhered by the resin or plastic. The insert, generally, can be made of metal or another plastic. In this invention, the insert is any material suitable to achieve microwaving shielding. Insert molding can be accomplished with a wide variety of materials, including polyethylene, polystyrene, polypropylene, polyvinyl chloride, thermoplastic elastomers, and many engineering plastics.

The insert, and plastic or resin, can be held together (i.e., bonded) by either molecular or mechanical means. For molecular bonding, best results are achieved when the insert material is the same or similar to the encapsulating resin or plastic. Mechanical bonding can be achieved by shrinking resin or plastic around the insert while the resin or plastic cools down during the insert molding process. Alternatively, mechanical bonding can occur when resin or plastic covers irregularities in the surface of the insert material. The end result of insert molding, as applied to this invention, is the intimate incorporation of microwave shielding material to the inner and/or outer portion of the package used to contain the foodstuff. “Insert molding” and other suitable processes will be recognized by those skilled in the packaging arts. See http://www.devicelink.com/mddi/archive/96/04/010.html, which is hereby incorporated by reference.

The width of the band may vary, depending on container size. As a general, but non-limiting, guidance, for a container having a side wall height of about 4 inches, the shielding band will be generally from about ½ inch to about 1½ inches wide, more preferably from about ¾ inches to about 1¼ inches wide. The corresponding surface area coverage of the side walls will vary generally from about 15 to 65%, more preferably from about 20 to 55%.

While two bands are illustrated, any suitable number of bands may be used. The bands may be in the form of vertical strips extending generally from the top to the bottom of the container. Furthermore, the strips or bands used can be regular or irregular in shape. Where bands are used around a bottom portion of a rounded-bottomed container, the dimensions of the band will vary from the top part of the band toward the bottom part of the band, to accommodate the curvature of the rounded corner.

The container of this invention may optionally include an overcap. The overcap can be a standard overcap or a locking overcap. The overcap may optionally have vent holes in the top surface of the overcap. The preferred placement of the holes includes holes located around the perimeter region of the top of the overcap and/or in the central region of the top of the overcap. Vent holes of varying diameters can be used, and the number of vent holes around the perimeter can also be varied, depending on the cap size and foodstuff. The vent holes in the examples below had a diameter of about 5/32 of an inch. Again, the size may vary, but will be readily determinable by routine methods. Shielding material may also be located on the overcap. The shield may cover from 0% to about 90%, preferably 20% to 90%, most preferably 50% to 90%, of the top surface area of the overcap. Such an overcap shield may, but need not, have vent holes.

### EXAMPLES

Preferred embodiments of the invention will be further described by the following Examples which are illustrative only and do not limit the invention. The container used in the examples below had a rounded bottom edge. The containers used were made from Polypropylene manufactured by Rexam. The containers are known as a “401” container. The containers had a Plastishield label, and the shielding material, in the form of a band, was placed on top of the label, except for a few examples, as indicated, where the shield was placed underneath the label. For shielding, aluminum foil or aluminum tape of about 5 mil. thickness was used. Placement of the shield is as indicated in the examples. Where bottom shields were used, since the containers had a rounded bottom-edge, the bottom bands covered part of the side wall, and extended downward to cover part of the bottom of the container. The bottom shields never completely covered the bottom of the container, so that a central portion of the bottom was left uncovered.

Overcaps with or without vent holes were used, as indicated in the specific examples. Location of the vent holes, which were about 5/32 of an inch in diameter, were located either around the general perimeter of the top of the overcap, in the general center of the overcap, or both. In some examples, overcaps had shields. When used, the shielding on the overcap covered about 90% of the top surface area of the overcap. When shields were used on the overcap, and vent holes were also incorporated, the vent hole perforations were made in both the overcap and the overcap shield.

Various soups were used for the examples below. Containers were placed on the outer area of the microwave turntable. Samples were heated in either a 900 watt microwave (Panasonic) at high power or a 1200 watt microwave at high power. After heating for about 2 minutes, samples were stirred for 15 seconds, after which temperature was measured with a digital thermometer at various randomly chosen locations to obtain a high and low temperature. Other observations reflecting optimization of heating and microwave activity were also noted. The use of shielding reduced the activity (e.g., splatter, movement of container, generation of audible noises) during heating, as indicated in the Examples provided. This reduction in microwave activity reflects that heating had been optimized in comparison to the controls.

### EXAMPLES

### Example 1

Test: ½ Shield (shield covering top half of side wall of the container)
Soup: 15.25 oz. Campbell's ® Chunky Beef with Country Vegetables
Microwave: 900 watt Panasonic
Top shield: top half
Bottom shield: none
Perimeter vent holes: none
Vent holes in central region: 4 vent holes in center

| | Temperature (F.) | | |
|---|---|---|---|
| Sample | @ 2 min. cook | Movement/Audible Noise | Splatter |
| 1 | Min: 127.7 | Yes, slight | No |
| | Max: 133.2 | | |
| 2 | Min: 101.0 | No | No |
| | Max: 131.9 | | |
| 3 | Min: 121.6 | Yes | No |
| | Max: 135.5 | | |
| 4 | Min: 111.9 | Slight | No |
| | Max: 126.8 | | |
| 5 | Min: 124.8 | No | No |
| | Max: 132.1 | | |

Control (no shield)
Soup: 15.25 oz. Campbell's ® Chunky Beef with Country Vegetables
Microwave: 900 watt Panasonic
Top shield:
Bottom shield:
Perimeter vent holes:
Vent holes in central region: 4

| | Temperature | | |
|---|---|---|---|
| | (F.) @ 2 min. | | |
| Sample | cook | Movement/Audible Noise | Splatter |
| 1 | Min: 139.8 | Heavy | No |
| | Max: 153.0 | | |
| 2 | Min: 141.8 | Moderate/heavy | Yes |
| | Max: 157.2 | | |
| 3 | Min: 138.5 | Heavy | Yes; |
| | Max: 152.0 | | |

### Example 2

Test: 2 Part Shield: top band & bottom band extending toward bottom
(center uncovered)
Soup: 15.25 oz. Campbell's ® Chunky Beef with Country Vegetables
Microwave: 1200 watt
Top shield: ½ inch
Bottom shield: ½ inch wide above surface of table +
additional ½ inch extending toward bottom.
Perimeter vent holes:
Vent holes in central region: 4

| | Temperature (F.) | | |
|---|---|---|---|
| Sample | @ 2 min. cook | Movement/Audible Noise | Splatter |
| 1 | Min: 132.2 | very slight | No |
| | Max: 138.0 | | |
| 2 | Min: 130.6 | No | No |
| | Max: 141.4 | | |

### Example 3

Test: 2 Part Shield: top band & bottom band extending toward bottom
(center uncovered)
Soup: 15.25 oz. Campbell's ® Chunky Beef with Country Vegetables
Microwave: 1200 watt
Top shield: ⅜ inch
Bottom shield: ½ inch wide above surface of table +
additional ½ inch extending toward bottom.
Perimeter vent holes:
Vent holes in central region: 4

| | Temperature (F.) | | |
|---|---|---|---|
| Sample | @ 2 min. cook | Movement/Audible Noise | Splatter |
| 1 | Min: 134.2 | very slight | No |
| | Max: 142.7 | | |
| 2 | Min: 131.6 | No | No |
| | Max: 141.5 | | |
| 3 | Min: 130.6 | Very slight | No |
| | Max: 139.7 | | |
| 4 | Min: 132.9 | No | No |
| | Max: 142.1 | | |

### Example 4

Test: Top & bottom
Soup: 15.25 oz. Campbell's ® Chunky Chicken & Dumplings
Microwave: 1200 watt
Top shield: ⅜ inch
Bottom shield: ½ inch wide above surface of table +
additional ½ inch extending toward bottom.
Perimeter vent holes:
Vent holes in central region: 4

| | Temperature (F.) | | |
|---|---|---|---|
| Sample | @ 2 min. cook | Movement/Audible Noise | Splatter |
| 1 | Min: 134.9 | No | No |
| | Max: 143.4 | | |
| Control | Min: 145.5 | Heavy | Yes |
| | Max: 151.7 | | |

### Example 5

Test: top & bottom
Soup: 15.25 oz. Campbell's ® Select 98% Fat Free New England
Clam Chowder
Microwave: 1200 watt
Top shield: ⅜ inch
Bottom shield: ½ inch wide above surface of table +
additional ½ inch extending toward bottom.
Perimeter vent holes:
Vent holes in central region: 4

| | Temperature (F.) | | |
|---|---|---|---|
| Sample | @ 2 min. cook | Movement/Audible Noise | Splatter |
| 1 | Min: 138.3 | No | No |
| | Max: 146.3 | | |
| 2 | Min: 133.5 | No | No |
| | Max: 143.8 | | |

### Example 6

Test: bottom only
Soup: 15.25 oz. Campbell's ® Select 98% Fat Free New England
Clam Chowder
Microwave: 1200 watt
Top shield:
Bottom shield: ¾ inch total width, including portion extending toward
bottom.
Perimeter vent holes:
Vent holes in central region: 4

| | Temperature (F.) | | |
|---|---|---|---|
| Sample | @ 2 min. cook | Movement/Audible Noise | Splatter |
| 1 | Min: 127.5 | No | No |
| | Max: 131.3 | | |
| 2 | Min: 130.1 | No | No |
| | Max: 138.9 | | |
| 3 | Min: 129.2 | No | No |
| | Max: 134.6 | | |
| 4 | Min: 132.4 | No | No |
| | Max: 137.8 | | |
| 5 | Min: 125.4 | Slight/moderate | No |
| | Max: 135.5 | | |

### Example 7

Test: 1 inch band around middle of container side wall
(i.e. around “waist”)
Soup: 15.25 oz. Campbell's ® Chunky Beef with Country Vegetables
Microwave: 1200 watt
Top shield:
Bottom shield:
Perimeter vent holes:
Vent holes in central region: 4

| | Temperature (F.) | | |
|---|---|---|---|
| Sample | @ 2 min. cook | Movement/Audible Noise | Splatter |
| 1 | Min: 138.9 | Heavy | No |
| | Max: 161.7 | | |
| 2 | Min: 143.4 | Yes | |
| | Max: 152.4 | | |

### Example 8

Test: Bottom only
Soup: 15.25 oz. Campbell's ® Chunky Beef with Country Vegetables
Microwave: 1200 watt
Top shield:
Bottom shield: ¾ inch total width, including portion extending
around corner toward bottom.
Perimeter vent holes:
Vent holes in central region: 4

| | Temperature (F.) | | |
|---|---|---|---|
| Sample | @ 2 min. cook | Movement/Audible Noise | Splatter |
| 1 | Min: 130.8 | No | No |
| | Max: 141.8 | | |
| 2 | Min: 139.2 | Moderate | No |
| | Max: 151.8 | | |
| 3 | Min: 142.1 | No | No |
| | Max: 156.7 | | |
| 4 | Min: 136.1 | No | No |
| | Max: 157.6 | | |

### Example 9

Test: Control (no shield)
Soup: 15.25 oz. Campbell's ® Chunky Chicken & Dumplings
Microwave: 1200 watt
Top shield:
Bottom shield:
Perimeter vent holes:
Vent holes in central region: 4

| | Temperature (F.) | | |
|---|---|---|---|
| Sample | @ 2 min. cook | Movement/Audible Noise | Splatter |
| Control-1 | Min: 141.2 | Heavy | Yes |
| | Max: 153.1 | | |
| Control-2 | Min: 145.7 | Moderate/Heavy | Yes |
| | Max: 156.9 | | |
| Control-3 | Min: 136.9 | Heavy | Yes |
| | Max: 147.3 | | |

### Example 10

Test: Control (no shield)
Soup: 15.25 oz. Campbell's ® Select 98% Fat Free New England
Clam Chowder Control
Microwave: 1200 watt
Top shield:
Bottom shield:
Perimeter vent holes:
Vent holes in central region: 4

| | Temperature (F.) | | |
|---|---|---|---|
| Sample | @ 2 min. cook | Movement/Audible Noise | Splatter |
| Control-1 | Min: 146.4 | Heavy | No |
| | Max: 150.8 | | |
| Control-2 | Min: 136.7 | Very heavy | Yes |
| | Max: 145.0 | | |
| Control-3 | Min: 139.1 | Heavy | Yes |
| | Max: 149.3 | | |
| Control-4 | Min: 141.0 | Heavy | Yes |
| | Max: 154.9 | | |
| Control-5 | Min: 142.7 | Heavy | No |
| | Max: 149.3 | | |

### Example 11

Test: bottom only
Soup: 15.25 oz. Campbell's ® Chicken & Dumplings
Microwave: 1200 watt
Top shield:
Bottom shield: ¾ inch total width, including potion extending
around corner toward bottom.
Perimeter vent holes:
Vent holes in central region: 4

| | Temperature (F.) | | |
|---|---|---|---|
| Sample | @ 2 min. cook | Movement/Audible Noise | Splatter |
| 1 | Min: 128.6 | No | No |
| | Max: 149.0 | | |
| 2 | Min: 132.4 | No | No |
| | Max: 153.0 | | |
| 3 | Min: 130.2 | No | No |
| | Max: 150.2 | | |

### Example 12

Test: bottom only
Soup: 15.25 oz. Campbell's ® Chunky Chicken & Dumplings
Microwave: 1200 watt
Top shield:
Bottom shield: ¾ inch total width, including potion extending
around corner toward bottom
Perimeter vent holes:
Vent holes in central region: 4

| | Temperature (F.) | | |
|---|---|---|---|
| | @ 2:10 min. | | |
| Sample | cook | Movement/Audible Noise | Splatter |
| 1 | Min: 137.8 | Very slight | No |
| | Max: 144.6 | | |
| 2 | Min: 133.7 | No | No |
| | Max: 148.8 | | |
| 3 | Min: 130.6 | No | No |
| | Max: 139.6 | | |

### Example 13

Test: Plastishield Label on top of and around bottom shield
Soup: 15.25 oz. Campbell's ® Chunky Beef with Country
Vegetables
Microwave: 1200 watt
Top shield:
Bottom shield: ½ inch
Perimeter vent holes:
Vent holes in central region: 4

| | Temperature (F.) | | |
|---|---|---|---|
| Sample | @ 2:10 min. cook | Movement/Audible Noise | Splatter |
| 1 | Min: 139.4 | Very slight | No |
| | Max: 157.6 | | |
| 2 | Min: 139.1 | Very slight | No |
| | Max: 156.2 | | |
| 3 | Min: 134.6 | | No |
| | Max: 149.1 | | |

### Example 14

Test: bottom only
Soup: 15.25 oz. Campbell's ® Select 98% Fat Free New England
Clam Chowder
Microwave: 900 watt Panasonic
Top shield:
Bottom shield: ½ inch
Perimeter vent holes:
Vent holes in central region: 4

| | Temperature (F.) | | |
|---|---|---|---|
| Sample | @ 2 min. cook | Movement/Audible Noise | Splatter |
| 1 | Min: 142.8 | Slight | No |
| | Max: 156.2 | | |
| 2 | Min: 139.1 | Very slight | No |
| | Max: 154.5 | | |
| 3 | Min: 135.3 | Very slight | No |
| | Max: 147.3 | | |
| 4 | Min: 132.2 | No | No |
| | Max: 142.5 | | |
| 5 | Min: 133.1 | No | No |
| | Max: 148.3 | | |

### Example 15

Test: Control (No Shield and No Label)
Soup: 15.25 oz. Campbell's ® Chunky New England
Clam Chowder
Microwave: 900 watt Panasonic
Top shield:
Bottom shield:
Perimeter vent holes:
Vent holes in central region: 4

| | Temperature (F.) | | |
|---|---|---|---|
| Sample | @ 2 min. cook | Movement/Audible Noise | Splatter |
| 1 | Min: 147.3 | Moderate | No |
| | Max: 172.9 | | |
| 2 | Min: 140.0 | Heavy | Yes |
| | Max: 163.2 | | |
| 3 | Min: 134.7 | Heavy | No |
| | Max: 147.7 | | |
| 4 | Min: 140.8 | Moderate | No |
| | Max: 153.3 | | |
| 5 | Min: 142.8 | Heavy | Yes |
| | Max: 171.6 | | |

### Example 16

Test: bottom only; No Label
Soup: 15.25 oz. Campbell's ® Chunky New England Clam
Chowder
Microwave: 900 watt Panasonic
Top shield:
Bottom shield: ¾ inch total width, including potion extending
around corner toward bottom.
Perimeter vent holes:
Vent holes in central region: 4

| | Temperature (F.) | | |
|---|---|---|---|
| Sample | @ 2 min. cook | Movement/Audible Noise | Splatter |
| 1 | Min: 132.8 | Moderate | No |
| | Max: 147.9 | | |
| 2 | Min: 133.1 | No | No |
| | Max: 141.6 | | |
| 3 | Min: 127.0 | Very slight | No |
| | Max: 150.6 | | |

### Example 17

Test: top & bottom
Soup: 15.25 oz. Campbell's ® Select 98% Fat Free New England
Clam Chowder
Microwave: 1200 watt microwave
Top shield: ½ inch
Bottom shield: ¾ inch total width, including potion extending
around corner toward bottom.
Perimeter vent holes:
Vent holes in central region: 4

| | Temperature (F.) | | |
|---|---|---|---|
| Sample | @ 2 min. cook | Movement/Audible Noise | Splatter |
| 1 | Min: 135.6 | No | Yes; |
| | Max: 141.8 | | |
| 2 | Min: 137.7 | Yes; moderate | Yes; |
| | Max: 142.6 | | |

### Example 18

Test: top & bottom
Soup: 15.25 oz. Campbell's ® Select 98% Fat Free New England
Clam Chowder
Microwave: 1200 watt microwave
Top shield: ⅝ inch
Bottom shield: ¾ inch total width, including potion extending
around corner toward bottom.
Perimeter vent holes:
Vent holes in central region: 4

| | Temperature (F.) | | |
|---|---|---|---|
| Sample | @ 2 min. cook | Movement/Audible Noise | Splatter |
| 1 | Min: 134.8 | No | Yes |
| | Max: 145.6 | | |

### Example 19

Test: Full Body Shield (with center of base left uncovered): Locking
Overcap
Soup: 15.25 oz. Campbell's ® Select 98% Fat Free New England
Clam Chowder
Microwave: 1200 watt microwave
Top shield: one continuous shield extending from top edge toward and
around corner to bottom
Bottom shield: leaving center of bottom uncovered
Perimeter vent holes:
Vent holes in central region: 4

| | Temperature (F.) | | |
|---|---|---|---|
| Sample | @ 2 min. cook | Movement/Audible Noise | Splatter |
| 1 | Min: 120 | Very slight | Slight |
| | Max: 125 | | |

### Example 20

Test: top & bottom
Soup: 15.25 oz. Campbell's ® Select 98% Fat Free New England
Clam Chowder
Microwave: 1200 watt microwave
Top shield: ⅝ inch
Bottom shield: 1¼ inch total width, including portion extending
around corner toward bottom.
Perimeter vent holes:
Vent holes in central region: 4

| | Temperature (F.) | Movement/Audible | |
|---|---|---|---|
| Sample | @ 2 min. cook | Noise | Splatter |
| 1 | Min: 125 | Yes; moderate | Yes |
| | Max: 132 | | |

### Example 21

Test: ½ inch foil strips spaced ½ inch apart vertically around
container wall; Center panel shield on overcap; 5 extra vent holes
in Overcap
Soup: 15.25 oz. Campbell's ® Select 98% Fat Free New England
Clam Chowder
Microwave: 1200 watt microwave
Perimeter vent holes: 5
Vent holes in central region: 4

| | Temperature (F.) | | |
|---|---|---|---|
| Sample | @ 2 min. cook | Movement/Audible Noise | Splatter |
| 1 | Min: 148 | Yes; slight | No |
| | Max: 160 | | |

### Example 22

Test: ½ inch foil strips spaced ½ inch apart vertically around
container wall; Center panel shield on locking overcap; 13 extra vent holes
in Overcap
Soup: 15.25 oz. Campbell's ® Select 98% Fat Free New England
Clam Chowder
Microwave: 1200 watt microwave
Perimeter vent holes: 13
Vent holes in central region: 4

| | Temperature (F.) | | |
|---|---|---|---|
| Sample | @ 2 min. cook | Movement/Audible Noise | Splatter |
| 1 | Min: 150 | Yes | Slight |
| | Max: 162 | moderate | |

### Example 23

Test: ½ inch foil strips spaced ½ inch apart vertically around
container wall; Center panel shield on locking overcap; 5 extra vent holes
in Overcap
Soup: 15.25 oz. Campbell's ® Select 98% Fat Free New England
Clam Chowder
Microwave: 1200 watt microwave
Perimeter vent holes: 5
Vent holes in central region: 4

| | Temperature (F.) | | |
|---|---|---|---|
| Sample | @ 2 min. cook | Movement/Audible Noise | Splatter |
| 1 | Min: 142 | Yes | Slight |
| | Max: 161 | moderate | |

### Example 24

Test: top & middle (waist) & bottom; overcap shielded and vented with
17 holes.
Soup: 15.25 oz. Campbell's ® Select 98% Fat Free New England
Clam Chowder
Microwave: 1200 watt microwave
Top shield: ½ inch
Middle shield: ½ inch
Bottom shield: ¾ inch total width, including portion extending
around corner toward bottom.
Perimeter vent holes: 13
Vent holes in central region: 4

| | Temperature (F.) | | |
|---|---|---|---|
| Sample | @ 2 min. cook | Movement/Audible Noise | Splatter |
| 1 | Min: 120 | Yes | Slight |
| | Max: 147 | Moderate. | |

### Example 25

Test: top & bottom; overcap with shield and 5 extra vent holes punched.
Soup: 15.25 oz. Campbell's ® Select 98% Fat Free New England
Clam Chowder
Microwave: 1200 watt microwave
Top shield: ⅞ inch
Bottom shield: 1 inch total width, including portion extending
around corner toward bottom.
Perimeter vent holes: 5
Vent holes in central region: 4

| | Temperature (F.) | | |
|---|---|---|---|
| Sample | @ 2 min. cook | Movement/Audible Noise | Splatter |
| 1 | Min: 133 | Yes | Slight |
| | Max: 149 | slight | |

### Example 26

Test: top & bottom; overcap with shield
Soup: 15.25 oz. Campbell's ® Select 98% Fat Free New England
Clam Chowder
Microwave: 1200 watt microwave
Top shield: 1 inch
Bottom shield: 1½ inch total width, including portion extending
around corner toward bottom.
Perimeter vent holes:
Vent holes in central region: 4

| | Temperature (F.) | | |
|---|---|---|---|
| Sample | @ 2 min. cook | Movement/Audible Noise | Splatter |
| 1 | Min: 128 | Very slight | No |
| | Max: 143 | | |

### Example 27

Test: top & bottom; overcap with shield
Soup: 15.25 oz. Campbell's ® Select 98% Fat Free New England
Clam Chowder
Microwave: 1200 watt microwave
Top shield: 1 inch
Bottom shield: 1½ inch total width, including portion extending
around corner toward bottom.
Perimeter vent holes:
Vent holes in central region: 4

| | Temperature (F.) | | |
|---|---|---|---|
| Sample | @ 2 min. cook | Movement/Audible Noise | Splatter |
| 1 | Min: 129 | Yes slight | No |
| | Max: 145 | | |

### Example 28

Test: top & bottom; overcap with shield
Soup: 15.25 oz. Campbell's ® Select 98% Fat Free New England
Clam Chowder
Microwave: 1200 watt microwave
Top shield: 1 inch
Bottom shield: 1½ inch total width, including portion extending
around corner toward bottom.
Perimeter vent holes: 12
Vent holes in central region: 4

| | Temperature (F.) | | |
|---|---|---|---|
| Sample | @ 2 min. cook | Movement/Audible Noise | Splatter |
| 1 | Min: 131 | Yes moderate. | Yes |
| | Max: 142 | | |

### Example 29

Test: top & bottom; overcap with shield
Soup: 15.25 oz. Campbell's ® Select 98% Fat Free New England
Clam Chowder
Microwave: 1200 watt microwave
Top shield: 1⅛ inch
Bottom shield: ⅞ inch total width, including portion extending
around corner toward bottom.
Perimeter vent holes: 8
Vent holes in central region: center vent holes covered

| | Temperature (F.) | | |
|---|---|---|---|
| Sample | @ 2 min. cook | Movement/Audible Noise | Splatter |
| 1 | Min: 142 | No | No. |
| | Max: 154 | | |

### Example 30

Test: top & bottom; overcap with shield
Soup: 15.25 oz. Campbell's ® Select 98% Fat Free New England
Clam Chowder
Microwave: 1200 watt microwave
Top shield: 1½ inch
Bottom shield: ⅞ inch total width, including portion
extending around corner toward bottom.
Perimeter vent holes: 12
Vent holes in central region: 4

| | Temperature (F.) | | |
|---|---|---|---|
| Sample | @ 2 min. cook | Movement/Audible Noise | Splatter |
| 1 | Min: 154 | No | No. |
| | Max: 157 | | |

### Example 31

Test: top & bottom; overcap
Soup: 15.25 oz. Campbell's ® Select 98% Fat Free New England
Clam Chowder
Microwave: 1200 watt microwave
Top shield: 1⅛ inch
Bottom shield: ⅞ inch total width, including portion
extending around corner toward bottom.
Perimeter vent holes: 12
Vent holes in central region: 4

| | Temperature (F.) | | |
|---|---|---|---|
| Sample | @ 2 min. cook | Movement/Audible Noise | Splatter |
| 1 | Min: 147 | Very slight one time | No. |
| | Max: 155 | | |

### Example 32

Test: top & bottom; overcap with shield
Soup: 15.25 oz. Campbell's ® Select 98% Fat Free New England
Clam Chowder
Microwave: 1200 watt microwave
Top shield: 1⅛ inch
Bottom shield: ⅞ inch total width, including portion
extending around corner toward bottom.
Perimeter vent holes: 12
Vent holes in central region: center vent holes covered

| | Temperature (F.) | | |
|---|---|---|---|
| Sample | @ 2 min. cook | Movement/Audible Noise | Splatter |
| 1 | Min: 145 | Very slight | Some |
| | Max: 159 | | |

### Example 33

Test: top & bottom; overcap
Soup: 15.25 oz. Campbell's ® Select 98% Fat Free New England
Clam Chowder
Microwave: 1200 watt microwave
Top shield: 1⅛ inch
Bottom shield: ⅞ inch total width, including portion
extending around corner toward bottom.
Perimeter vent holes: 12
Vent holes in central region: 4

| | Temperature (F.) | | |
|---|---|---|---|
| Sample | @ 2 min. cook | Movement/Audible Noise | Splatter |
| 1 | Min: 154 | Very slight | Some |
| | Max: 157 | | |

### Example 34

Test: top & bottom; overcap
Soup: 15.25 oz. Campbell's ® Select 98% Fat Free New England
Clam Chowder
Microwave: 1200 watt microwave
Top shield: 1⅛ inch
Bottom shield: ⅞ inch total width, including portion
extending around corner toward bottom.
Perimeter vent holes:
Vent holes in central region: 4

| | Temperature (F.) | | |
|---|---|---|---|
| Sample | @ 2 min. cook | Movement/Audible Noise | Splatter |
| 1 | Min: 142 | No | No. |
| | Max: 154 | | |

### Example 35

Test: Control (no shield)
Soup: 15.25 oz. Campbell's ® Select 98% Fat Free New England
Clam Chowder
Microwave: 1200 watt microwave
Perimeter vent holes:
Vent holes in central region: 4

| | Temperature (F.) | | |
|---|---|---|---|
| Sample | @ 2 min. cook | Movement/Audible Noise | Splatter |
| 1 | Min: 157 | Yes, moderate | No |
| | Max: 167 | | |
| 2 | Min: 149 | No | No |
| | Max: 166 | | |

### Example 36

Test: top & bottom; overcap
Soup: 15.25 oz. Campbell's ® Select 98% Fat Free New England
Clam Chowder
Microwave: 1200 watt microwave
Top shield: 1⅛ inch
Bottom shield: ⅞ inch total width, including portion
extending around corner toward bottom.
Perimeter vent holes:
Vent holes in central region: 4

| | Temperature (F.) | | |
|---|---|---|---|
| Sample | @ 2 min. cook | Movement/Audible Noise | Splatter |
| 1 | Min: 141 | Very slight | No. |
| | Max: 149 | | |

### Example 37

Test: top & bottom; overcap
Soup: 15.25 oz. Campbell's ® Select 98% Fat Free New England
Clam Chowder
Microwave: 1200 watt microwave
Top shield: 1⅛ inch
Bottom shield: ⅞ inch total width, including portion
extending around corner toward bottom.
Perimeter vent holes: 12
Vent holes in central region: 4

| | Temperature (F.) | | |
|---|---|---|---|
| Sample | @ 2 min. cook | Movement/Audible Noise | Splatter |
| 1 | Min: 153 | No | No. |
| | Max: 157 | | |

### Example 38

Test: top & bottom; overcap
Soup: 15.25 oz. Campbell's ® Chunky Sirloin Burger with Vegetables
Microwave: 1200 watt microwave
Top shield: 1⅛ inch
Bottom shield: ⅞ inch total width, including portion
extending around corner toward bottom.
Perimeter vent holes: 12
Vent holes in central region: 4

| | Temperature (F.) | | |
|---|---|---|---|
| Sample | @ 2 min. cook | Movement/Audible Noise | Splatter |
| 1 | Min: 149 | Slight | No. |
| | Max: 156 | | |

### Example 39

Test: Control (no shield)
Soup: 15.25 oz. Campbell's ® Chunky Sirloin Burger with vegetables
Microwave: 1200 watt microwave
Perimeter vent holes: 12
Vent holes in central region: 4

| | Temperature (F.) | | |
|---|---|---|---|
| Sample | @ 2 min. cook | Movement/Audible Noise | Splatter |
| 1 | Min: 158 | Yes, heavy | Yes. |
| | Max: 168 | Cap fell off. | |

### Example 40

Test: top & bottom; overcap
Soup: 15.25 oz. Campbell's ® Select 98% Fat Free
New England Clam Chowder
Microwave: 1200 watt microwave
Top shield: 1⅛ inch
Bottom shield: 1 inch total width, including portion
extending around corner toward bottom.
Perimeter vent holes: 12
Vent holes in central region: 4

| | Temperature (F.) | Movement/Audible | |
|---|---|---|---|
| Sample | @ 2 min. cook | Noise | Splatter |
| 1 | Min: 149 | Yes, slight | No |
| | Max: 157 | | |

### Example 41

Test: top; overcap
Soup: 15.25 oz. Campbell's ® Select 98%
Fat Free New England Clam Chowder
Microwave: 1200 watt microwave
Top shield: 1¼ inch
Bottom shield:
Perimeter vent holes: 12
Vent holes in central region: 4

| | Temperature (F.) | Movement/Audible | |
|---|---|---|---|
| Sample | @ 2 min. cook | Noise | Splatter |
| 1 | Min: 152 | Yes, moderate. | No |
| | Max: 160 | | |

### Example 42

Test: top & bottom; overcap
Soup: 15.25 oz. Campbell's ® Select 98%
Fat Free New England Clam Chowder
Microwave: 1200 watt microwave
Top shield: 1⅛ inch
Bottom shield: 1 inch total width, including portion
extending around corner toward bottom.
Perimeter vent holes: 12
Vent holes in central region: 4

| | Temperature (F.) | Movement/Audible | |
|---|---|---|---|
| Sample | @ 2 min. cook | Noise | Splatter |
| 1 | Min: 144 | Yes | No |
| | Max: 158 | slight. | |

### Example 43

Test: top & bottom; overcap
Soup: 15.25 oz. Campbell's ® Select 98%
Fat Free New England Clam Chowder
Microwave: 1200 watt microwave
Top shield: 1⅛ inch
Bottom shield: 1 inch total width, including portion
extending around corner toward bottom.
Perimeter vent holes: 12
Vent holes in central region: 4

| | Temperature (F.) | Movement/Audible | |
|---|---|---|---|
| Sample | @ 2 min. cook | Noise | Splatter |
| 1 | Min: 137 | No | No |
| | Max: 147 | | |

### Example 44

Test: top & bottom; overcap
Soup: 15.25 oz. Campbell's ® Select 98%
Fat Free New England Clam Chowder
Microwave: 1200 watt microwave
Top shield: 1¼ inch
Bottom shield: 1 inch total width, including portion
extending around corner toward bottom.
Perimeter vent holes: 12
Vent holes in central region: 4

| | Temperature (F.) | Movement/Audible | |
|---|---|---|---|
| Sample | @ 2 min. cook | Noise | Splatter |
| 1 | Min: 142 | No | No |
| | Max: 151 | | |

### Example 45

Test: top & bottom; overcap
Soup: 15.25 oz. Campbell's ® Chunky Chicken & Dumplings
Microwave: 1200 watt microwave
Top shield: 1⅛ inch
Bottom shield: 1 inch total width, including portion
extending around corner toward bottom.
Perimeter vent holes: 12
Vent holes in central region: 4

| | Temperature (F.) | Movement/Audible | |
|---|---|---|---|
| Sample | @ 2 min. cook | Noise | Splatter |
| 1 | Min: 141 | Very slight | No |
| | Max: 149 | | |

### Example 46

Test: Control (no shield)
Soup: 15.25 oz. Campbell's ® Chunky Chicken & Dumplings
Microwave: 1200 watt microwave
Perimeter vent holes: 12
Vent holes in central region: 4

| | Temperature (F.) | Movement/Audible | |
|---|---|---|---|
| Sample | @ 2 min. cook | Noise | Splatter |
| 1 | Min: 151 | Mod. To heavy. | Yes. |
| | Max: 165 | Overcap lifted | |
| 2 | Min: 152 | Heavy | Heavy |
| | Max: 162 | | |

### Example 47

Test: top & bottom; overcap
Soup: 15.25 oz. Campbell's ® Chunky Chicken & Dumplings
Microwave: 1200 watt microwave
Top shield: 1⅛ inch
Bottom shield: 1⅛ inch total width, including
portion extending around corner toward
bottom.
Perimeter vent holes: 12
Vent holes in central region: 4

| | Temperature (F.) | Movement/Audible | |
|---|---|---|---|
| Sample | @ 2 min. cook | Noise | Splatter |
| 1 | Min: 146 | No | No |
| | Max: 159 | | |

### Example 48

Test: top & bottom; overcap
Soup: 15.25 oz. Campbell's ® Select 98%
Fat Free New England Clam Chowder
Microwave: 1200 watt microwave
Top shield: 1⅛ inch
Bottom shield: 1⅛ inch total width, including
portion extending around corner toward
bottom.
Perimeter vent holes: 12
Vent holes in central region: 4

| | Temperature (F.) | Movement/Audible | |
|---|---|---|---|
| Sample | @ 2 min. cook | Noise | Splatter |
| 1 | Min: 145 | No | No |
| | Max: 157 | | |
| 2 | Min: 141 | No | No |
| | Max: 153 | | |

### Example 49

Test: top & bottom; overcap
Soup: 15.25 oz. Campbell's ® Chunky Chicken & Dumplings
Microwave: 1200 watt microwave
Top shield: 1 1/8 inch
Bottom shield: 1⅛ inch total width, including
portion extending around corner toward bottom.
Perimeter vent holes: 12
Vent holes in central region: 4

| | Temperature (F.) | Movement/Audible | |
|---|---|---|---|
| Sample | @ 2 min. cook | Noise | Splatter |
| 1 | Min: 150 | No | No |
| | Max: 154 | | |

### Example 50

Test: top & bottom; overcap
Soup: 15.25 oz. Campbell's ® Chunky Chicken & Dumplings
Microwave: 1200 watt microwave
Top shield: 1⅛ inch
Bottom shield: 1⅛ inch total width, including portion extending
around corner toward bottom.
Perimeter vent holes: 0
Vent holes in central region: 4

| | Temperature (F.) | | |
|---|---|---|---|
| Sample | @ 2 min. cook | Movement/Audible Noise | Splatter |
| 1 | Min: 147 | Yes | No |
| | Max: 157 | Slight | |

### Example 51

Test: top & bottom; overcap
Soup: 15.25 oz. Campbell's ® Chunky Chicken & Dumplings
Microwave: 1200 watt microwave
Top shield: 1⅛ inch
Bottom shield: 1⅛ inch total width, including portion extending
around corner toward bottom.
Perimeter vent holes: 0
Vent holes in central region: 4

| | | | |
|---|---|---|---|
| | Temperature (F.) | | |
| Sample | @ 2 min. cook | Movement/Audible Noise | Splatter |

| | | | |
|---|---|---|---|
| 1 | Min: 150 | No | No |
| | Max: 157 | | |

### Example 52

Test: top & bottom; overcap
Soup: 15.25 oz. Campbell's ® Chunky Chicken & Dumplings
Microwave: 1200 watt microwave
Top shield: 1⅛ inch
Bottom shield: 1⅛ inch total width, including portion extending
around corner toward bottom.
Perimeter vent holes: 12
Vent holes in central region: 4

| | Temperature (F.) | | |
|---|---|---|---|
| Sample | @ 2 min. cook | Movement/Audible Noise | Splatter |
| 1 | Min: 148 | No | No |
| | Max: 154 | | |

### Example 53

Test: top & bottom; overcap
Soup: 15.25 oz. Campbell's ® Select 98% Fat Free New England
Clam Chowder
Microwave: 1200 watt microwave
Top shield: 1⅛ inch
Bottom shield: 1⅛ inch total width, including portion extending
around corner toward bottom.
Perimeter vent holes: 0
Vent holes in central region: 4

| | Temperature (F.) | | |
|---|---|---|---|
| Sample | @ 2 min. cook | Movement/Audible Noise | Splatter |
| 1 | Min: 148 | No | No |
| | Max: 152 | | |

### Example 54

Test: top & bottom; overcap
Soup: 15.25 oz. Campbell's ® Select 98% Fat Free New England
Clam Chowder
Microwave: 1200 watt microwave
Top shield: 1⅛ inch
Bottom shield: 1⅛ inch total width, including portion extending
around corner toward bottom.
Perimeter vent holes: 12
Vent holes in central region: 4

| | Temperature (F.) | | |
|---|---|---|---|
| Sample | @ 2 min. cook | Movement/Audible Noise | Splatter |
| 1 | Min: 145 | No | No |
| | Max: 152 | | |

### Example 55

Test: top & bottom; overcap
Soup: 15.25 oz. Campbell's ® Chunky Grilled Sirloin Steak
Microwave: 1200 watt microwave
Top shield: 1⅛ inch
Bottom shield: 1⅛ inch total width, including portion extending
around corner toward bottom.
Perimeter vent holes: 0
Vent holes in central region: 4

| | Temperature (F.) | | |
|---|---|---|---|
| Sample | @ 2 min. cook | Movement/Audible Noise | Splatter |
| 1 | Min: 144 | No | No |
| | Max: 153 | | |

### Example 56

Test: top & bottom; overcap
Soup: 15.25 oz. Campbell's ® Chunky Grilled Sirloin Steak
Microwave: 1200 watt microwave
Top shield: 1⅛ inch
Bottom shield: 1⅛ inch total width, including portion extending
around corner toward bottom.
Perimeter vent holes: 12
Vent holes in central region: 4

| | Temperature (F.) | | |
|---|---|---|---|
| Sample | @ 2 min. cook | Movement/Audible Noise | Splatter |
| 1 | Min: 145 | Very slight | No |
| | Max: 149 | | |

### Example 57

Test: Control
Soup: 15.25 oz. Campbell's ® Chunky Grilled Sirloin Steak
Microwave: 1200 watt microwave
Perimeter vent holes: 12
Vent holes in central region: 4

| | Temperature (F.) | | |
|---|---|---|---|
| Sample | @ 2 min. cook | Movement/Audible Noise | Splatter |
| 1 | Min: 153 | Mod. To heavy. | Yes. |
| | Max: 165 | | |
| 2 | Min: 155 | Yes | No |
| | Max: 168 | Heavy | |

### Example 58

Test: top & bottom; overcap
Soup: 15.25 oz. Campbell's ® Chunky Grilled Sirloin Steak
Microwave: 1200 watt microwave
Top shield: 1⅛ inch
Bottom shield: 1⅛ inch total width, including portion extending
around corner toward bottom.
Perimeter vent holes: 0
Vent holes in central region: 4

| | Temperature (F.) | | |
|---|---|---|---|
| Sample | @ 2 min. cook | Movement/Audible Noise | Splatter |
| 1 | Min: 144 | No | No. |
| | Max: 154 | | |
| 2 | Min: 144 | No | No |
| | Max: 152 | | |

### Example 59

Test: top & bottom; overcap
Soup: 15.25 oz. Campbell's ® Select 98% Fat Free New England
Clam Chowder
Microwave: 1200 watt microwave
Top shield: 1⅛ inch
Bottom shield: 1⅛ inch total width, including portion extending
around corner toward bottom.
Perimeter vent holes: 0
Vent holes in central region: 4

| | Temperature (F.) | | |
|---|---|---|---|
| Sample | @ 2 min. cook | Movement/Audible Noise | Splatter |
| 1 | Min: 149 | No. | No. |
| | Max: 158 | | |
| 2 | Min: 145 | Very slight | No |
| | Max: 153 | | |

### Example 60

Test: Control (No shield)
Soup: 15.25 oz. Campbell's ® Select 98% Fat Free New England
Clam Chowder
Microwave: 1200 watt microwave
Perimeter vent holes: 0
Vent holes in central region: 4

| | Temperature (F.) | | |
|---|---|---|---|
| Sample | @ 2 min. cook | Movement/Audible Noise | Splatter |
| 1 | Min: 144 | Yes. | Yes. |
| | Max: 157 | Heavy. | |
| 2 | Min: 148 | Very. | No |
| | Max: 157 | Mod-heavy | |

### Example 61

Test: Control (no shield)
Soup: 15.25 oz. Campbell's ® Chunky Chicken & Dumplings
Microwave: 1200 watt microwave
Perimeter vent holes: 0
Vent holes in central region: 4

| | Temperature (F.) | | |
|---|---|---|---|
| Sample | @ 2 min. cook | Movement/Audible Noise | Splatter |
| 1 | Min: 154 | Yes. | Yes. |
| | Max: 164 | Heavy. | |
| 2 | Min: 148 | Yes. | Yes |
| | Max: 164 | Heavy | |

### Example 62

Test: top & bottom; overcap
Soup: 15.25 oz. Campbell's ® Chunky Chicken & Dumplings
Microwave: 1200 watt microwave
Top shield: 1⅛ inch
Bottom shield: 1⅛ inch total width, including portion extending
around corner toward bottom.
Perimeter vent holes: 0
Vent holes in central region: 4

| | Temperature (F.) | | |
|---|---|---|---|
| Sample | @ 2 min. cook | Movement/Audible Noise | Splatter |
| 1 | Min: 146 | No. | No. |
| | Max: 158 | | |
| 2 | Min: 144 | No | No |
| | Max: 151 | | |

### Example 63

Test: Control (no shield)
Soup: 15.25 oz. Campbell's ® Chunky Beef and Country Vegetables
Microwave: 1200 watt microwave
Perimeter vent holes: 0
Vent holes in central region: 4

| | Temperature (F.) | | |
|---|---|---|---|
| Sample | @ 2 min. cook | Movement/Audible Noise | Splatter |
| | Min: 158 | Yes. | Some. |
| | Max: 171 | Heavy. | |
| 2 | Min: 150 | Yes. | No. |
| | Max: 175 | Heavy. | |

### Example 64

Test: top & bottom; overcap
Soup: 15.25 oz. Campbell's ® Chunky Beef with Country Vegetables
Microwave: 1200 watt microwave
Top shield: 1⅛ inch
Bottom shield: 1⅛ inch total width, including portion extending
around corner toward bottom.
Perimeter vent holes: 0
Vent holes in central region: 4

| | Temperature (F.) | | |
|---|---|---|---|
| Sample | @ 2 min. cook | Movement/Audible Noise | Splatter |
| 1 | Min: 150 | No. | No. |
| | Max: 160 | | |
| 2 | Min: 148 | No | No |
| | Max: 161 | | |

### Example 65

Test: top & bottom; overcap
Soup: 15.25 oz. Campbell's ® Select 98% Fat Free New England
Clam Chowder
Microwave: 1200 watt microwave
Top shield: 1⅛ inch
Bottom shield: 1⅛ inch total width, including portion extending
around corner toward bottom.
Perimeter vent holes: 0
Vent holes in central region: 4

| | Temperature (F.) | | |
|---|---|---|---|
| Sample | @ 2 min. cook | Movement/Audible Noise | Splatter |
| 1 | Min: 152 | No. | No. |
| | Max: 157 | | |
| 2 | Min: 149 | No | No |
| | Max: 155 | | |

### Example 66

Test: top & bottom; overcap
Soup: 15.25 oz. Campbell's ® Chunky Chicken & Dumplings
Microwave: 1200 watt microwave
Top shield: 1⅛ inch
Bottom shield: 1⅛ inch total width, including portion extending
around corner toward bottom.
Perimeter vent holes: 0
Vent holes in central region: 4

| | Temperature (F.) | | |
|---|---|---|---|
| Sample | @ 2 min. cook | Movement/Audible Noise | Splatter |
| 1 | Min: 148 | No. | No. |
| | Max: 160 | | |
| 2 | Min: 147 | No | No |
| | Max: 158 | | |

### Example 67

Test: Full shield on container, except base; standard overcap #1
Soup: 15.25 oz. Campbell's ® Chunky Chicken & Dumplings
Microwave: 1200 watt microwave
Top shield: full shield from top to bottom, except for base area
Bottom shield:
Perimeter vent holes: 0
Vent holes in central region: 4

| | Temperature (F.) | | |
|---|---|---|---|
| Sample | @ 2 min. cook | Movement/Audible Noise | Splatter |
| 1 | Min: 141 | Yes. | No. |
| | Max: 149 | Very heavy. | |

### Example 68

Test: top & bottom; overcap
Soup: 15.25 oz. Campbell's ® Chunky Grilled Sirloin Steak
Microwave: 1200 watt microwave
Top shield: 1⅛ inch
Bottom shield: 1⅛ inch total width, including portion extending
around corner toward bottom.
Perimeter vent holes: 0
Vent holes in central region: 4

| | Temperature (F.) | | |
|---|---|---|---|
| Sample | @ 2 min. cook | Movement/Audible Noise | Splatter |
| 1 | Min: 155 | No. | No. |
| | Max: 162 | | |
| 2 | Min: 146 | No | No |
| | Max: 151 | | |

### Example 69

Test: Full shield on container; standard overcap #1
Soup: 15.25 oz. Campbell's ® Select 98% Fat Free New England
Clam Chowder
Microwave: 1200 watt microwave
Top shield: full shield from to toward bottom
Bottom shield:
Perimeter vent holes: 0
Vent holes in central region: 4

| | Temperature (F.) | | |
|---|---|---|---|
| Sample | @ 2 min. cook | Movement/Audible Noise | Splatter |
| 1 | Min: 117 | Yes. | Yes. |
| | Max: 125 | Moderate. | |

Although preferred embodiments are specifically illustrated and described herein above, it will be appreciated that many modifications and variations of the present invention are possible in light of the above teachings and within the purview of the appended claims without departing from the spirit and intended scope of the invention.

I claim:

1. A container comprising microwave shielding material, the container having a bottom and side walls and including a foodstuff, said shielding material arranged together with a portion of the side walls, whereby microwave activity is reduced.

2. The container of claim 1 wherein the shielding material is in the form of at least one continuous band located at the bottom of the side walls of the container.

3. The container of claim 2 wherein said shielding material is at least one selected from the group consisting of metallic foil, metallic tape, metallic film, vaporized metal, and chemically deposited metal.

4. The container of claim 2 wherein said shielding material comprises a metal.

5. The container of claim 4 wherein said metal is aluminum.

6. The container of claim 4 wherein said band comprises at least one metallized plastic material.

7. The container of claim 2 wherein the band has a microwave opacity of at least 50%.

8. The container of claim 2 wherein the band has a microwave opacity of at least 90%.

9. The container of claim 6 wherein the metallized plastic includes at least one plastic material selected from the group consisting of polyethylene teraphthalate, polyamide, polyvinyliden chloride, polystyrene, polypropylene, high density polyethylene, and low density polyethylene.

10. The container of claim 1 wherein the shielding material is in the form of at least one continuous band located at the top of the side wall of the container.

11. The container of claim 2 further comprising a second continuous band at the top of the side wall of said container.

12. The container of claim 1 wherein the shielding material covers about 15% to 65% of the surface area of the side wall of said container.

13. The container of claim 12 wherein the shielding material covers about 20% to 55% of the surface area of the side wall of said container.

14. The container of claim 11 wherein said band and said second band have a width which is the same or different.

15. A method of reducing microwave activity associated with subjecting a foodstuff in a container to microwaves, the container having a bottom and side walls, said method comprising affixing shielding material to the side wall of said container.

16. The method of claim 15 comprising affixing shielding material in the form of at least one continuous band to the side walls.

17. The method of claim 16 comprising affixing said band on the bottom of the side walls.

18. The method of claim 16 wherein said shielding material is at least one selected from the group consisting of metallic foil, metallic tape, metallic film, vaporized metal, and chemically deposited metal.

19. The method of claim 16 wherein said shielding material comprises a metal.

20. The method of claim 19 wherein said metal is aluminum.

21. The method of claim 19 wherein said band comprises at least one metallized plastic material.

22. The method of claim 16 wherein the band has a microwave opacity of at least 50%.

23. The method of claim 16 wherein the band has a microwave opacity of at least 90%.

24. The method of claim 21 wherein the metallized plastic includes at least one plastic material selected from the group consisting of polyethylene teraphthalate, polyamide, polyvinyliden chloride, polystyrene, polypropylene, high density polyethylene, and low density polyethylene.

25. The method of claim 15 wherein the shielding material is in the form of at least one continuous band located at the top of the side wall of the container.

26. The method of claim 17 further comprising affixing a second continuous band at the top of the side wall of said container.

27. The method of claim 15 wherein the shielding material covers from about 15% to about 65% of the surface area of the side walls of said container.

28. The method of claim 27 wherein the shielding material covers from about 20% to about 55% of the surface area of the side wall of said container.

29. The method of claim 26 wherein said band and said second band have a width which is the same or different.
